(19) United States
(12) Patent Application Publication
(10) Pub. No.: US 2009/0076180 A1
(43) Pub. Date: Mar. 19, 2009

(54) Epoxy resin composition using latent curing agent and curable by photo and heat in combination

(76) Inventor: Kazuki Iwaya, Niigata-shi (JP)

Correspondence Address: MANELLI DENISON & SELTER, 2000 M STREET NW SUITE 700, WASHINGTON, DC, 20036-3307, US

(21) Appl. No.: 12/230,560

(22) Filed: Sep. 2, 2008

(30) Foreign Application Priority Data
Sep. 3, 2007 (JP) 2007-227798

(51) Int. Cl. C08L 63/00; C08G 59/68; C08K 3/04; C08K 5/3417

(52) U.S. Cl. 522/31; 522/170; 522/109; 522/71; 522/75

(57) ABSTRACT

The present invention is to provide a latent curing type epoxy resin composition which comprises
(A) 100 parts by weight of an epoxy resin,
(B) 5 to 25 parts by weight of a cation polymerization photo initiator, and
(C) 5 to 35 parts by weight of at least one heatset anion curing agent selected from the group consisting of an epoxy adduct with an amine compound, a urea adduct with an amine compound and a compound in which an isocyanate compound is added to a hydroxyl group of an epoxy adduct with an amine compound.

### TECHNICAL FIELD

The present invention relates to an epoxy resin composition using latent curing agent and curable by photo and heat in combination.

### BACKGROUND ART

In recent years, a curable epoxy resin composition has widely been used for attaching an electronic element(s) to a package or fixing an electronic part(s) to a substrate. In curing mechanisms of an epoxy resin composition, there are a heat curable type and a photo curable type. In the former one, adhesiveness is good, but a viscosity of the composition once lowers before curing so that there are problems that the resin composition flows whereby a position of an electronic element(s), etc. is deviated, and a possibility of damaging an electronic element(s), etc. occurs by heat at the time to curing. In the latter case, curing can be done at a normal temperature, and thus, there is no deterioration of the electronic element(s), etc. by heat. However, the electronic element(s), etc. are cubic materials so that there is a problem that photo does not reach to a deep portion whereby a portion which is insufficient in curing remains.

Thus, to complement the defects of the both types, it has been investigated a photo-heat combination type curable epoxy resin composition (see Patent Literature 1, Patent Literature 2). Incidentally, in a photo-curing type, there are a type using a cation polymerization photo initiator and a type using a radical polymerization photo initiator. In a heat curable type, there are a type using a heatset anion curing agent and a type using a heatset cation curing agent. Here, when the cation polymerization photo initiator and the heatset anion curing agent are used in combination, even when a cation which is an initiating species is generated by photo-irradiation, it is deactivated by the heatset anion curing agent, so that curability by photo is insufficient whereby the above combination is considered to be effective. In Patent Literatures 1 and 2, specifically disclosed compositions are only those which use a cation polymerization photo initiator and a heatset cation curing agent in combination.

However, a composition which uses a cation polymerization photo initiator and a heatset cation curing agent in combination involves the problems that increase in electric conductance or corrosion occurs, which causes bad effects on reliability of an electronic material (s). This is considered as one of causes that a pH of the cured product(s) shows an acidic. On the other hand, when a radical polymerization photo initiator is used, the presence of an acrylate compound is generally essential. In addition, due to polymerization reaction of the acrylate compound, shrinkage in volume is remarkable, and there is a problem that it is inferior in adhesive force to the case where a cation polymerization photo initiator is used.

A composition which uses a cation polymerization photo initiator and a base which is capsulated and binds to a polymer in combination has recently been proposed (see Patent Literature 3), but the base of the composition is only able to neutralize the system which became acidic by the cation polymerization photo reaction, and does not have a function of initiating heatset anion curing.

### [Patent Literature 1] JP 5-335101A

### [Patent Literature 2] JP 2004-352821A

### [Patent Literature 3] JP 2007-512414A

### DISCLOSURE OF THE INVENTION

### Problems to be Solved by the Invention

An object of the present invention is to provide a photo-heat combination type latent curing type epoxy resin composition which shows sufficient provisional curability by practically used photo, and effective for ensuring reliability necessary for an electronic materials(s).

### Means to Solve the Problems

The present inventors have earnestly investigated, and as a result, they have found that the above-mentioned problems can be solved by using a specific heatset anion curing agent with a cation polymerization photo initiator in combination, whereby the present invention has been accomplished.

The present invention relates to

1. a latent curing type epoxy resin composition which comprises
(A) 100 parts by weight of an epoxy resin,
(B) 5 to 25 parts by weight of a cation polymerization photo initiator, and
(C) 5 to 35 parts by weight of at least one heatset anion curing agent selected from the group consisting of an epoxy adduct with an amine compound, a urea adduct with an amine compound and a compound in which an isocyanate compound is added to a hydroxyl group of an epoxy adduct with an amine compound.

The present invention preferably comprises the following constitutions.

2. The latent curing type epoxy resin composition of the above-mentioned 1, wherein Component (B) is at least one of a sulfonium salt and an iodonium salt.
3. The latent curing type epoxy resin composition of the above-mentioned 1 or 2, wherein Component (C) is a compound in which an isocyanate compound is added to a hydroxyl group of an epoxy adduct with an amine compound.
4. The latent curing type epoxy resin composition of any one of the above-mentioned 1 to 3, wherein it further comprises (D) a phenol resin.
5. The latent curing type epoxy resin composition of any one of the above-mentioned 1 to 4, wherein a thickness of a cured epoxy resin composition is 70 m or higher, when the composition is filled in a cylindrical apparatus having a diameter of 14 mm and a height of 8 mm and cured by irradiating ultraviolet rays of a high-pressure mercury lamp upward with an illumination of 200 mW/cm² for 10 seconds, then, a cured product is taken out from the apparatus, an uncured portion attached to the cured product is removed and a thickness of the cured product is measured.
6. The latent curing type epoxy resin composition of any one of the above-mentioned 1 to 5, wherein it further comprises at least one colorant (E) selected from the group consisting of carbon black, iron black, iron yellow, chrome green and phthalocyanine blue.
7. An electronic part fixed by using the latent curing type epoxy resin composition of any one of the above-mentioned 1 to 6.
8. A package to which an electronic image element is attached by using the latent curing type epoxy resin composition of any one of the above-mentioned 1 to 6.

### EFFECTS OF THE INVENTION

According to the present invention, it is provided a photo-heat combination type latent curing type epoxy resin composition which shows sufficient provisional curability by practically used photo, and effective for ensuring reliability necessary for an electronic material(s).

### BEST MODE TO CARRY OUT THE INVENTION

The epoxy resin (A) in the present invention is not specifically limited so long as it is an epoxy compound that has two or more epoxy groups in one molecule. The epoxy resin (A) is a liquid state at a normal temperature (25 to 40 C), or a solid state at a normal temperature which shows a liquid state at a normal temperature by dissolving with a diluent such as a liquid state epoxy compound, etc. It is preferred that the epoxy resin (A) itself is a liquid state at a normal temperature.

More specifically, it can be exemplified by a bis-phenol A type epoxy resin, a brominated bisphenol A type epoxy resin, a bisphenol F type epoxy resin, a biphenyl type epoxy resin, a novolac type epoxy resin, an alicyclic epoxy resin, a naphthalene-containing epoxy resin, an ether series or polyether series epoxy resin, an oxirane ring-containing polybutadiene, a silicone epoxy copolymer resin, etc.

In particular, as an epoxy resin which is a liquid state at a normal temperature, there may be exemplified by a bisphenol A type epoxy resin having an average molecular weight of about 400 or less; a branched polyfunctional bisphenol A type epoxy resin such as p-glycidyloxyphenyl dimethyltolylbisphenol A diglycidyl ether represented by the formula:

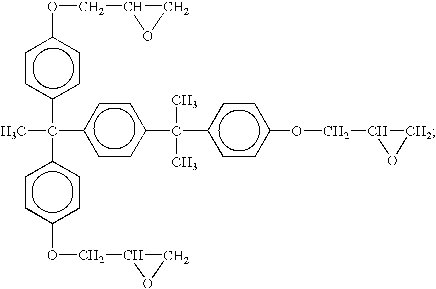

a bisphenol F type epoxy resin; a phenol novolac type epoxy resin having an average molecular weight of about 570 or less; an alicyclic epoxy resin such as vinyl(3,4-cyclohexene)dioxide, methyl 3,4-epoxycyclohexylcarboxylate (3,4-epoxycyclohexyl), bis(3,4-epoxy-6-methylcyclohexylmethyl)adipate and 2-(3,4-epoxycyclohexyl)-5,1-spiro(3,4-epoxycyclohexyl)-m-dioxane; a biphenyl type epoxy resin such as 3,3′,5,5′-tetramethyl-4,4′-diglycidyloxybiphenyl; a glycidyl ester type epoxy resin such as diglycidyl hexahydrophthalate, diglycidyl 3-methylhexahydro phthalate and diglycidyl hexahydroterephthalate, etc.; a glycidylamine type epoxy resin such as diglycidylaniline, diglycidyltoluidine, triglycidyl-p-aminophenol, tetraglycidyl-m-xylylene diamine, tetraglycidylbis(aminomethyl)cyclohexane; and a hidantoin type epoxy resin such as 1,3-diglycidyl-5-methyl-5-ethylhidantoin; and a naphthalene ring-containing epoxy resin. These epoxy resins may be used alone or in combination of two or more kinds.

Also, the epoxy resin(s) which is/are a liquid state at a normal temperature may be used in combination with an epoxy resin which is a solid or in an ultra-high viscosity at a normal temperature. Such an epoxy resin may be exemplified by a bisphenol A type epoxy resin, a novolac epoxy resin, a tetrabromobisphenol A type epoxy resin, etc., each of which have a high-molecular weight.

When a diluent such as a liquid state epoxy compound, etc., is to be used for dissolving the epoxy resin which is a solid or in an ultra-high viscosity at a normal temperature, both of a non-reactive diluent and a reactive diluent may be used, and a reactive diluent is preferably used. The reactive diluent is a compound having a relatively low viscosity at a normal temperature and having 1 or 2 or more epoxy groups in one molecule. It may have other polymerizable functional group other than the epoxy group, depending on the purposes, e.g., an alkenyl group such as vinyl, allyl, etc.; or an unsaturated carboxylic acid residue such as acryloyl, methacryloyl, etc. Such a reactive diluent may be exemplified by a monoepoxide compound such as n-butyl glycidyl ether, 2-ethylhexyl glycidyl ether, phenyl glycidyl ether, cresyl glycidyl ether, p-s-butylphenyl glycidyl ether, styreneoxide and apinene oxide; a monoepoxide compound having other functional group(s) such as allyl glycidyl ether, glycidyl methacrylate and 1-vinyl-3,4-epoxycyclohexane; a diepoxide compound such as (poly)ethyleneglycol diglycidyl ether, (poly)propyleneglycol diglycidyl ether, butanediol glycidyl ether and neopentylglycol diglycidyl ether; and a triepoxide compound such as trimethylolpropane triglycidyl ether and triglycidyl ether, etc.

(B) the cation polymerization photo initiator in the present invention is not specifically limited so long as it is a compound which is capable of generating a cation initiator species by irradiation of activation energy rays. The activation energy rays may be mentioned γ rays, X rays, electron beam, ultraviolet rays, visible rays, infrared rays, etc., and ultraviolet rays are preferred in the points of reactivity, safety and economical viewpoint.

As the cation polymerization photo initiator, an onium salt may be mentioned, and specifically mentioned are an iodonium salt, a sulfonium salt, an ammonium salt, a phosphonium salt, a diazonium salt or a pyridinium salt represented by the formula:

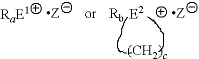

wherein R may be the same or different from each other, and each represents an unsubstituted or substituted monovalent hydrocarbon group; E¹ represents an iodine atom, a sulfur atom, a nitrogen atom, a phosphorus atom, a diazo group or unsubstituted or ring-substituted pyridinio group; E² represents a sulfur atom or a nitrogen atom; Z represents a counter ion in which 1 to 6 substituent(s) selected from the group consisting of a halogen atom, a hydroxyl group, a substituted or unsubstituted phenyl group and a substituted or unsubstituted alkyl group is/are bonded to a metal selected from the group consisting of copper, zinc, titanium, vanadium, chromium, aluminum, tin, gallium, zirconium, indium, manganese, iron, cobalt and nickel or a metalloid selected from the group consisting of boron, antimony, arsenic and phosphor; a is 2 when E¹ is an iodine atom, is 3 when it is a sulfur atom, is 4 when it is a nitrogen atom or a phosphorus atom, and is 1 when it is a diazo group or an unsubstituted or ring-substituted pyridinio group; b is 1 when E² is a sulfur atom, and is 2 when it is a nitrogen atom; and c is an integer of 4 or 5,
   and they may be used singly or in combination of two or more.

As R, there may be mentioned a straight or branched alkyl group preferably having 1 to 15 carbon atoms such as a methyl, ethyl, propyl, butyl, pentyl, octyl, decyl, dodecyl and tetradecyl; a cycloalkyl group preferably having 3 to 10 carbon atoms such as a cyclohexyl; an aryl group such as a phenyl, 4-tolyl, 4-cumyl, 2,4-xylyl and 1-naphthyl; an aralkyl group in which an alkyl group having 1 to 15 carbon atoms is substituted by an aryl group preferably having 6 to 20 carbon atoms, such as benzyl, 2-methylbenzyl, 4-methylbenzyl, 2-phenylethyl and 1-naphthylmethyl; an alkenyl group preferably having 2 to 10 carbon atoms such as vinyl, allyl and butenyl; and a monovalent substituted hydrocarbon group preferably derived from the above-mentioned preferred hydrocarbon groups, such as 4-hydroxyphenyl, 4-methoxyphenyl, 4-ethoxyphenyl, 4-cyanophenyl, 4-chlorophenyl, 4-acetoxyphenyl, 4-propanoylphenyl, 4-methoxycarbonylphenyl, 4-ethoxycarbonylphenyl, 4-methoxybenzyl, 4-ethoxybenzyl, 4-t-butoxybenzyl, 4-nitrobenzyl, 4-cyanobenzyl and 4-phenylthiophenyl. At least one of R s in the molecule is preferably an aryl group or an aralkyl group since the composition shows excellent curability, and more preferably all the R s are such a group(s).

E¹ is as mentioned above, and as the unsubstituted or ring-substituted pyridinio group, there may be exemplified by, in addition to a pyridinio group, a ring-substituted pyridinium group such as a 2- or 4-methylpyridinio, 2,4-dimethylpyridinio, 2- or 4-cyanopyridinio, 2- or 4-methoxycarbonylpyridinio and 2- or 4-ethoxycarbonylpyridinio, etc. As the E¹ or E², an iodine atom or sulfur atom is preferred since excellent curing rate can be obtained.

Z is as described above, and preferably a counter ion in which 4 to 6 substituents selected from the group consisting of a halogen atom selected from a fluorine atom and a chlorine atom, a halogen atom(s)-substituted or unsubstituted phenyl group and a halogen atom(s)-substituted or unsubstituted alkyl group are bound to a metal selected from iron and tin or a metalloid selected from the group consisting of boron, antimony, arsenic and phosphorus, more preferably BF₄, PF₆, (CF₃CF₂)₃ PF₃, (CF₃CF₂CF₂)₃ PF₃, AsF₆, SbF₆, (C₆F₅)₄B, (C₆H₄CF₃)₄B, (C₆H₅)₂BF₂, C₆H₅BF₃, (C₆H₃F₂)₄B, FeCl₄, SnCl₆ or SbCl₆. Of these, (CF₃CF₂)₃ PF₃, (CF₃CF₂CF₂)₃ PF₃, SbF₆, B(C₆F₅)₄ or PF₆ are particularly preferred since they gives excellent curing property by a short time of photo-irradiation.

As such a preferred onium salt, there may be preferably exemplified by a hexafluoroantimonic acid salt, a hexafluorophosphoric acid salt, tris(heptafluoropropyl)-trifluorophosphoric acid salt or a tetrakis(pentafluorophenyl)boron salt of a diaryl iodonium such as diphenyl iodonium, phenyl(4-tolyl)iodonium, phenyl(4-cumyl)iodonium, phenyl(4-t-butylphenyl)iodonium, di(4-tolyl)iodonium, 4-tolyl(4-cumyl)iodonium, 4-tolyl(4-t-butylphenyl)iodonium, di(4-cumyl)iodonium, 4-cumyl(4-t-butylphenyl)iodonium and di(4-t-butylphenyl)iodonium; a substituted aryl group-containing iodonium such as phenyl(4-methoxyphenyl)iodonium, bis(4-methoxyphenyl)iodonium; an aralkyl group-containing iodonium such as phenylbenzyl iodonium; a triaryl sulfonium such as triphenyl sulfonium, diphenyl(4-t-butylphenyl)sulfonium and tritolyl sulfonium; a substituted aryl group-containing sulfonium such as tris(4-hydroxyphenyl)sulfonium, tris(4-methoxyphenyl)sulfonium, tris(4-ethoxyphenyl)sulfonium, tris(acetoxyphenyl)sulfonium and diphenyl[4-(phenylthio)-phenyl]sulfonium; benzyl structure-containing sulfonium such as methyl(4-hydroxyphenyl)benzyl sulfonium and methyl-(4-methoxyphenyl)-1-naphthylmethyl sulfonium, and a hexafluorophosphate is preferred in the point of safety, and diphenyl[4-(phenylthio)phenyl]sulfonium hexafluorophosphate, diphenyl[4-(phenylthio)phenyl]sulfonium tetrakis(pentafluorophenyl)borate and/or diphenyl[4-(phenylthio)phenyl]sulfonium tris(heptafluoropropyl)trifluorophosphate is/are particularly preferred, and diphenyl[4-(phenylthio)phenyl]sulfonium tetrakis(pentafluorophenyl)-borate and diphenyl[4-(phenylthio)phenyl]sulfonium tris-(heptafluoropropyl)trifluorophosphate are most preferred in the point of thermal stability.

The present invention is characterized in that the above-mentioned Component (B) and at least one of the heatset anion curing agent (C) selected from the group consisting of an epoxy adduct with an amine compound, a urea adduct with an amine compound and a compound in which an isocyanate compound is added to a hydroxyl group of an epoxy adduct with an amine compound in combination. According to this embodiment, an active cation species which is generated by irradiation of activation energy and proceeds cation polymerization, is not deactivated, whereby it is possible to give the composition sufficient photo-curability. Of these, in the point of provisional adhesion strength after photo-curing, a compound in which an isocyanate compound is added to a hydroxyl group of an epoxy adduct with an amine compound is preferred. In the present specification, “the heatset anion curing agent” means an anion polymerization curing agent which reacts by heat.

As the amine compound, it is not specifically limited so long as it has at least one active hydrogen atom capable of effecting addition reaction with an epoxy group in the molecule. Such an amine compound may be mentioned, for example, an aliphatic amine compound such as diethylenetriamine, triethylenetetramine, n-propylamine, 2-hydroxyethylaminopropylamine, cyclohexylamine, 4,4,-diamino-dicyclohexylmethane, etc.; an aromatic amine compound such as 4,4′-diaminodiphenylmethane, 2-methylaniline, etc.; an imidazole compound such as imidazole, 2-methylimidazole, 2-ethylimidazole, 2-isopropylimidazole, 2-undecylimidazole, 2-dodecylimidazole, 2-phenylimidazole, 2-ethyl-4-methylimidazole, 2-benzylimidazole, 2,4,5-trimethylimidazole, etc.; and an imidazoline compound such as imidazoline, 2-methylimidazoline, 2-ethylimidazoline, 2-isopropylimidazoline, 2-undecylimidazoline, 2-phenylimidazoline, 2-ethyl-4-methylimidazoline, 2-benzylimidazoline and 2,4,5-trimethylimidazoline, etc.

The epoxy adduct can be obtained by reacting an amine compound with an epoxy compound. Also, when an isocyanate compound is subjected to addition reaction to the hydroxyl group of the epoxy adduct, cation species are blocked by an isocyanate group over the surface of an anion product.

As the epoxy compound, there may be mentioned 1,2-epoxybutane, 1,2-epoxyhexane, 1,2-epoxyoctane, styreneoxide, butyl glycidyl ether, hexyl glycidyl ether, phenyl glycidyl ether, glycidyl acetate, glycidyl butyrate, glycidyl hexoate, glycidyl benzoate, etc.

As the isocyanate compound, there may be mentioned phenyl isocyanate, p-methyl phenyl isocyanate, o-methyl phenyl isocyanate, p-methoxyphenyl isocyanate, 2,4-dimethylphenyl isocyanate, o-chlorophenyl isbcyanate, p-chlorophenyl isocyanate, methyl isocyanate, ethyl isocyanate, propyl isocyanate, butyl isocyanate, hexyl isocyanate, etc.

The urea adduct can be obtained by reacting an amine compound and an isocyanate compound or a urea compound. The amine compound and the isocyanate compound include those as exemplified above. As the urea compound, there may be mentioned urea, thiourea, etc.

Component (C) can be also produced by a method as disclosed in JP 61-268723A or JP59-59720A. Also, the epoxy adduct is available as, for example, AMICURE MY-24, AMICURE PN-23 (each available from Ajinomoto Fine-Techno Co., Inc., trade name), etc., the material in which isocyanate compound is subjected to addition reaction with a hydroxyl group of an epoxy adduct also contains a so-called micro-capsulated imidazol and, for example, is available as NOVACURE HX-3088 and NOVACURE HX-3722 (each available from Asahi Kasei Chemicals Corp., trade name), etc., and the urea adduct is available as, for example, FUJICURE FXE-1000 and FUJICURE FXB-1050 (each available from Fuji Kasei Kogyo K.K., trade name), etc.

The composition of the present invention comprises 5 to 25 parts by weight of Component (B) and 5 to 35 parts by weight of Component (C) based on 100 parts by weight of Component (A) in the points of giving sufficient provisional adhesive strength, and also giving desired adhesive strength in the final cured product. It is more preferably 10 to 20 parts by weight of Component (B), and 10 to 30 parts by weight of Component (C).

The composition of the present invention preferably further comprises (D) a phenol resin as an aid of the heatset anion curing agent. As Component (D), there may be mentioned a phenol novolac resin, a triphenol methane resin, a terpene-modified phenol resin, a dicyclopentadiene-modified phenol resin, a phenol aralkyl resin (containing a phenylene skeletone), a naphthol aralkyl resin, etc. In Component (D), those in which the phenol portion is substituted by an alkyl group or an allyl group are contained and, for example, there may be mentioned a cresol novolac resin and a phenol novolac resin substituted by an allyl group. Those in which the phenol portion is substituted are preferred in the point of improving curing property.

Component (D) is preferably 1 to 80 parts by weight based on 100 parts by weight of Component (A), more preferably 1 to 40 parts by weight.

When the composition is required to have a photo-shielding property like a sealing agent for an electronic image element(s), (E) a colorant may be further contained in the composition of the present invention. As a colorant, there may be mentioned a black pigment such as carbon black, iron black, black lead oxide, Cr—Cu complex oxide, Cu—Fe—Mn complex oxide, etc.; an inorganic colorant such as titanium white, iron oxide, iron yellow, cobalt blue, chrome green, etc.; and an organic colorant such as chromophthal series, quinacridone series, phthalocyanine series, azo series colorant, etc. In the composition of the present invention, even when a photo-shielding component such as carbon black, etc. is formulated, it finally gives sufficient curability since it is a photo-heat combination type.

Component (E) is preferably 0.1 to 5 parts by weight based on 100 parts by weight of Component (A), more preferably 0.1 to 2 parts by weight.

The composition of the present invention may contain a conventionally used component such as a coupling agent, a flame retardant, etc., if necessary, in the range which does not impair the effects of the present invention. Also, a (meth)acrylate monomer or a (meth)acrylate oligomer may be contained in the composition as a photo-curing promoter.

The composition of the present invention can be prepared by mixing respective component uniformly using a kneader, a stirring mixer, a triple roll mill, etc.

The composition of the present invention is a latent curing type composition which can be cured by irradiating activation energy rays, and then, heating the same. The activation energy rays may be mentioned γ rays, X rays, electron beam, ultraviolet rays, visible rays, infrared rays, etc., and ultraviolet rays are preferred. As a photo source, a high-pressure mercury lamp, a metal halide lamp, LED, etc. can be used. For example, when the composition of the present invention does not contain Component (E), the composition is filled in a cylindrical apparatus made of a polyethylene, etc., and having a diameter of 14 mm and a height of 8 mm, and cured by irradiating ultraviolet rays of a high-pressure mercury lamp upward with an illumination of 200 mW/cm² for 10 seconds. Then, a cured product is taken out from the apparatus, an uncured portion attached to the cured product is removed and when a thickness of the cured product is measured, it shows sufficient curability showing a thickness of 70 μm or higher.

Then, by heating the material, it can be cured completely. In the point of giving heat to electronic element(s) or electronic part(s) as little as possible, the conditions of heating is preferably at 60 to 150° C., more preferably 60 to 120° C.

The composition of the present invention can be used for attaching an electronic element(s) to a package, or fixing an electronic part(s). In particular, to develop sufficient adhesive property by irradiation of activation energy rays, it is suitable for the use in which a material is adhered strictly to a predetermined position such as attachment of an electronic image element including CCD, etc.

Moreover, according to the composition of the present invention, a pH of the cured product(s) can be expected to be around neutral to weakly basic (pH: 6 to 10), whereby it is expected that occurrence of migration of a lead wire on a substrate can be prevented at a high temperature and high humidity, and good characteristics can be developed.

### EXAMPLES

In the following, the present invention is explained in detail by referring to Examples, but the present invention is not limited by these. The indication means part(s) by weight otherwise specifically mentioned.

Samples of Examples and Comparative examples were obtained with the formulation shown in Table 1 and mixing the each component by using a mixer. Each component is as follows.

Bisphenol A epoxy resin; epoxy equivalent: 165 g/eq
Bisphenol F epoxy resin; epoxy equivalent: 160 g/eq
Urethane acrylate oligomer number average molecular weight: 13,500
Bisphenol A epoxy resin acrylic acid-added oligomer; number average molecular weight: 380
Microcapculated imidazol A: NOVACURE HX-3088 available from Asahi Kasei Chemicals (a mixture of a microcapculated imidazol and a bisphenol A type epoxy resin in a weight ratio of 1:2. In Table 1, it is a value as a mixture)
Microcapculated imidazol B: NOVACURE HX-3722 available from Asahi Kasei Chemicals (a mixture of a microcapculated imidazol and a bisphenol A type epoxy resin in a weight ratio of 1:2. In Table 1, it is a value as a mixture)
Epoxy adduct amine: AMICURE MY-24 available from Ajinomoto Fine-Techno Co., Inc.
Epoxy adduct imidazole: AMICURE PN-23 available from Ajinomoto Fine-Techno Co., Inc.
Phenol resin: MEH-8005 available from MEIWA PLASTICS INDUSTRIES, LTD.

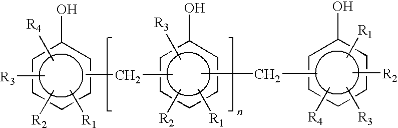

wherein R₁ to R₄ each represent hydrogen or an allyl group, and n=0 to 3.
   Carbon black: average particle diameter: 80 nm, specific surface area (nitrogen adsorption method): 24 m²/g

With regard to the obtained samples of Examples and Comparative examples, the following measurements were carried out.

### (1) Photo-Curing Depth

Each sample of Examples and Comparative examples was filled in a headcap HC-10U-G (a diameter of 14 mm and a height of 8 mm) for UV syringe manufactured by Musashi Engineering Co., Ltd., and irradiation of ultraviolet rays (high-pressure mercury lamp, 200 mW/cm², 10 seconds) was carried out. Cured product was taken off from the apparatus, uncured portion attached to the cured product was removed off, and a thickness of the cured portion was measured by using a dial gauge. The results are shown in Table 2. The larger the thickness is, the better the curability by photo means. In general, when no colorant is contained, the thickness of the cured portion is desirably 70 μm or higher.

### (2) Photo-Curing Adhesive Strength

Each sample of Examples and Comparative examples was subjected to lithographic printing on a glass piece with a size of 2 mmφ and a thickness of about 125 μm. On the printed sample, an Si chip having a size of 2 mm×2 mm was disposed, irradiation of ultraviolet rays (high-pressure mercury lamp, 200 mW/cm², 10 seconds) was carried out through a glass, and a shear strength was measured by a universal testing machine. As the strength of provisional fixing, it depends on a weight of an article to be fixed, and it is generally preferably 0.3 kgf or higher. The results are shown in Table 2.

### (3) Heat-Curing Adhesion Strength

Each sample of Examples and Comparative examples was subjected to lithographic printing on a glass piece with a size of 2 mmφ and a thickness of about 125 μm. On the printed sample, an Si chip having a size of 2 mm×2 mm was disposed, irradiation of ultraviolet rays (high-pressure mercury lamp, 200 mW/cm², 10 seconds) was carried out through a glass, and heat-curing was carried out under the conditions shown in Table 1 by using a cure oven or a hot plate and a shear strength was measured by a universal testing machine. As the adhesion strength, it is preferably 6.0 kgf or higher. The results are shown in Table 2.

### (4) Breaking Mode Test

After the measurement of the above-mentioned (3) heat-curing adhesion strength, a breaking surface was observed. The results are shown in Table 2.

Si cohesive failure shows that the Si chip is in a collapsed state. Si-side interface peeling shows that it becomes a peeled state at an interface between the Si chip and the sample. In Example which shows Si cohesive failure, heat-curing adhesion strength is due to breakage by the Si chip so that it can be said that an inherent adhesion strength is higher than the measured value.

### (5) pH Test Regarding Cured Product

Each sample of Examples and Comparative examples was coated on a clean UPILEX with a thickness of 350±100 μm, and cured by the same photo-irradiation and heating conditions as in the above-mentioned (3), and the resulting cured product was crushed with one edge of about 5 mm or so. To 2.5 g of the crushed product was added 25 g of deionized water and the mixture was placed in an apparatus made of Teflon (registered trademark), placed in a pressure cooker at 121±2° C. for 20 hours, and cooled to 20±3° C. and the resulting extract was sued as a test liquid. This test liquid was measured by a pH meter PH81 manufactured by Yokogawa Electric Corporation. The results are shown in Table 2.

### (6) Weight Loss Test by Heating

Each sample of Examples and Comparative examples was coated on a glass plate with a thickness of 350 100 m, provisionally cured by the same photo-irradiation conditions as in the above-mentioned (3), and further thermally cured at 120° C. for 30 minutes. A weight at that time was measured, and then, the cured product was further heated at 250° C. for 1 minute on a hot plate and a weight after the heat treatment was measured. The less weight change occurs, the better the curability at low temperature means. The results are shown in Table 2.

Comparative example 1 which is a combined type of the radical polymerization photo initiator and the heatset anion curing agent was insufficient in photo-curability, and Comparative example 2 which is a combined type of the radical polymerization photo initiator and the heatset cation curing agent and Comparative example 3 which uses the cation photo initiator were both insufficient in photo-curability and yet adhesion strength by heating was insufficient and a pH of the extracted water of the cured product(s) showed to be an acidic. On the other hand, all the cured products of Examples 1 to 7 each showed sufficient photo-curability, and high adhesion strength by heating. Moreover, according to Example 1, a pH of the extracted aqueous solution of a cured product was weakly basic.

TABLE 1

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| Epoxy | Bisphenol A | 19.0 | 19.0 | 53.0 | 53.0 | 16.5 | 19.0 | 16.5 | 34.9 | 19.0 | 19.0 |
| resin | epoxy resin | | | | | | | | | | |
| | Bisphenol F | 20.0 | 20.0 | 20.0 | 20.0 | 17.5 | 20.0 | 17.5 | 35.0 | 20.0 | 20.0 |
| | epoxy resin | | | | | | | | | | |
| Cation | Diphenyl[4- | 10.0 | 10.0 | 10.0 | 10.0 | 10.0 | 10.0 | 10.0 | 10.0 | | |
| polymeri- | (phenylthio)- | | | | | | | | | | |
| zation | phenyl]sul- | | | | | | | | | | |
| photo | fonium hexa- | | | | | | | | | | |
| initiator | fluoro- | | | | | | | | | | |
| | phosphate | | | | | | | | | | |
| | Diphenyl[4- | | | | | | | | | 10.0 | |
| | (phenylthio)- | | | | | | | | | | |
| | phenyl]sul- | | | | | | | | | | |
| | fonium tetrakis- | | | | | | | | | | |
| | (pentafluoro- | | | | | | | | | | |
| | phenyl)borate | | | | | | | | | | |
| | Diphenyl[4- | | | | | | | | | | 10.0 |
| | (phenylthio)- | | | | | | | | | | |
| | phenyl]sul- | | | | | | | | | | |
| | fonium tris(penta- | | | | | | | | | | |
| | fluoropropyl)tri- | | | | | | | | | | |
| | fluorophosphate | | | | | | | | | | |
| Heatset | Microcapsulated | | 51.0 | | | | | | | | |
| anion | imidazol A | | | | | | | | | | |
| curing | Microcapsulated | 51.0 | | | | 51.0 | 51.0 | 51.0 | 20.1 | 51.0 | 51.0 |
| agent | imidazol B | | | | | | | | | | |
| | Epoxy adduct | | | | 17.0 | | | | | | |
| | amine | | | | | | | | | | |
| | Epoxy adduct | | | 17.0 | | | | | | | |
| | imidazole | | | | | | | | | | |
| Additives | Phenol resin | | | | | 5.0 | | 5.0 | | | |
| | Carbon black | | | | | | 0.5 | 0.5 | | | |

| | | | | | | | | | | |
|---|---|---|---|---|---|---|---|---|---|---|
| Total | 100.0 | 100.0 | 100.0 | 100.0 | 100.0 | 100.5 | 100.5 | 100.0 | 100.0 | 100.0 |
| Heat curing conditions | 80° C. × | 120° C. × | 80° C. × | 120° C. × | 80° C. × | 80° C. × | 80° C. × | 80° C. × | 80° C. × | 80° C. × |
| | 1 h, oven | 1 h, oven | 1 h, oven | 1 h, oven | 1 h, oven | 1 h, oven | 1 h, oven | 1 h, oven | 1 h, oven | 1 h, oven |

| | | Compar- | Compar- | Compar- | Compar- | Compar- | Compar- | Compar- | Compar- |
|---|---|---|---|---|---|---|---|---|---|
| | | ative | ative | ative | ative | ative | ative | ative | ative |
| | | example 1 | example 2 | example 3 | example 4 | example 5 | example 6 | example 7 | example 8 |
| Epoxy resin | Bisphenol A epoxy resin | 10.5 | 23.8 | 25.0 | 53.0 | 53.0 | 53.0 | 53.0 | 40.1 |
| | Bisphenol F epoxy resin | 11.5 | 23.8 | 25.0 | 20.0 | 20.0 | 20.0 | 20.0 | 40.0 |
| Acryl oligomer | Urethane acrylate oligomer | 9.0 | 9.0 | | | | | | |
| | Bisphenol A type epoxy | 17.0 | 17.0 | | | | | | |
| | resin acrylic acid-added | | | | | | | | |
| | oligomer | | | | | | | | |
| Oxetane | 1,4-Bis[(3-ethyl-3- | | 23.0 | 45.0 | | | | | |
| | oxetanyl- | | | | | | | | |
| | methoxy)methyl]benzene | | | | | | | | |
| Cation | Diphenyl[4-(phenylthio)- | | | | 10.0 | 10.0 | 10.0 | 10.0 | 10.0 |
| polymeri- | phenyl]sulfonium hexa- | | | | | | | | |
| zation | fluorophosphate | | | | | | | | |
| photo | Tricumyliodonium | | 1.7 | 3.5 | | | | | |
| initiator | tetrakis(pentafluoro- | | | | | | | | |
| | phenyl)borate | | | | | | | | |
| Radical | 2,4,6-Trimethylbenzyol | 1.0 | 1.0 | | | | | | |
| polymeri- | diphenylphosphine oxide | | | | | | | | |
| zation photo | | | | | | | | | |
| initiator | | | | | | | | | |
| Cation | Diethylthioxanthone | | 0.7 | 1.5 | | | | | |
| polymeri- | | | | | | | | | |
| zation photo | | | | | | | | | |
| initiating | | | | | | | | | |
| aid | | | | | | | | | |
| Heatset anion | Microcapsulated imidazol B | 51.0 | | | | | | | 9.9 |
| curing agent | 2-Phenyl-4-methylimidazole | | | | 17.0 | | | | |
| | Dicyanediamide | | | | | 17.0 | | | |
| | Bis(4-amino-3-methylcyclo- | | | | | | 17.0 | | |
| | hexyl)methane | | | | | | | | |
| | Polymethylaniline | | | | | | | 17.0 | |

| | | | | | | | | |
|---|---|---|---|---|---|---|---|---|
| Total | 100.0 | 100.0 | 100.0 | 100.0 | 100.0 | 100.5 | 100.5 | 100.0 |
| Heat curing conditions | 80° C. × | 120° C. × | 80° C. × | 80° C. × | 150° C. × | 120° C. × | 120° C. × | 80° C. × |
| | 1 h, oven | 1 h, oven | 1 h, oven | 1 h, oven | 1 h, oven | 1 h, oven | 1 h, oven | 1 h, oven |

TABLE 2

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| Evaluation | UV ray curability (cured | 100 | 150 | 90 | 140 | 85 | 40 | 50 | 130 | 140 | 135 |
| of photo- | depth) μm | | | | | | | | | | |
| cured | UV ray cure adhesion | 1.5 | 1.6 | 0.7 | 1.3 | 1.7 | 0.6 | 0.6 | 3.6 | 3.6 | 4.1 |
| product | strength Kgf | | | | | | | | | | |
| Evaluation | Heat cure adhesion | 18.8 | 14.3 | 20.8 | 17.8 | 14.9 | 15.8 | 16.3 | 6.2 | 18.4 | 13.0 |
| of heat- | strength Kgf | | | | | | | | | | |
| cured | Breakage mode | A* | A* | A* | A* | A* | A* | A* | A* + B* | A* | A* |
| product | Humidity resistance | 9.5 | N.A. | N.A. | N.A. | N.A. | N.A. | N.A. | N.A. | N.A. | N.A. |
| | test extracted water pH | | | | | | | | | | |
| | Heat loss % | 0.50 | N.A. | N.A. | N.A. | 0.40 | 0.70 | 0.50 | N.A. | N.A. | N.A. |

| | | Compar- | Compar- | Compar- | Compar- | Compar- | Compar- | Compar- | Compar- |
|---|---|---|---|---|---|---|---|---|---|
| | | ative | ative | ative | ative | ative | ative | ative | ative |
| | | example 1 | example 2 | example 3 | example 4 | example 5 | example 6 | example 7 | example 8 |
| Evaluation | UV ray curability (cured | 10 | 250 | 250 | 0 | 130 | 0 | 0 | 140 |
| of photo- | depth) μm | | | | | | | | |
| cured | UV ray cure adhesion | 0.4 | 0.8 | 2.8 | 0 | 0.4 | 0 | 0 | 3.1 |
| product | strength Kgf | | | | | | | | |
| Evaluation | Heat cure adhesion | 12.3 | 2.1 | 6.0 | 14.3 | 17.8 | 17.1 | 18.1 | 5.7 |
| of heat- | strength Kgf | | | | | | | | |
| cured | Breakage mode | B* | B* | B* | A* | A* | A* | A* | B* |
| product | Humidity resistance | 9.0 | 2.1 | 4.0 | N.A. | N.A. | N.A. | N.A. | N.A. |
| | test extracted water pH | | | | | | | | |
| | Heat loss % | N.A. | N.A. | N.A. | N.A. | N.A. | N.A. | N.A. | N.A. |

A* Si cohesive failure,
B* Si-side interface peeling,
N.A.: Not available (not measured)

### UTILIZABILITY IN INDUSTRY

The compositions of the present invention can be used for attaching an electronic element(s) to a package, or fixing an electronic part(s) to the same. In particular, it shows sufficient adhesive property by irradiation of activation energy rays, so that it is suitable for the use in which a material is adhered strictly to a predetermined position such as attachment of an electronic image element including CCD, etc.

What we claimed is:

1. A latent curing type epoxy resin composition which comprises
(A) 100 parts by weight of an epoxy resin,
(B) 5 to 25 parts by weight of a cation polymerization photo initiator, and
(C) 5 to 35 parts by weight of at least one heatset anion curing agent selected from the group consisting of an epoxy adduct with an amine compound, a urea adduct with an amine compound and a compound in which an isocyanate compound is added to a hydroxyl group of an epoxy adduct with an amine compound.

2. The latent curing type epoxy resin composition according to claim 1, wherein Component (B) is at least one of a sulfonium salt and an iodonium salt.

3. The latent curing type epoxy resin composition according to claim 1, wherein Component (C) is a compound in which an isocyanate compound is added to a hydroxyl group of an epoxy adduct with an amine compound.

4. The latent curing type epoxy resin composition according to claim 2, wherein Component (C) is a compound in which an isocyanate compound is added to a hydroxyl group of an epoxy adduct with an amine compound.

5. The latent curing type epoxy resin composition according to claim 1, wherein it further comprises (D) a phenol resin.

6. The latent curing type epoxy resin composition according to claim 2, wherein it further comprises (D) a phenol resin.

7. The latent curing type epoxy resin composition according to claim 3, wherein it further comprises (D) a phenol resin.

8. The latent curing type epoxy resin composition according to claim 4, wherein it further comprises (D) a phenol resin.

9. The latent curing type epoxy resin composition according to claim 1, wherein a thickness of a cured epoxy resin composition is 70 μm or higher, when the composition is filled in a cylindrical apparatus having a diameter of 14 mm and a height of 8 mm and cured by irradiating ultraviolet rays of a high-pressure mercury lamp upward with an illumination of 200 mW/cm² for 10 seconds, then, a cured product is taken out from the apparatus, an uncured portion attached to the cured product is removed and a thickness of the cured product is measured.

10. The latent curing type epoxy resin composition according to claim 2, wherein a thickness of a cured epoxy resin composition is 70 μm or higher, when the composition is filled in a cylindrical apparatus having a diameter of 14 mm and a height of 8 mm and cured by irradiating ultraviolet rays of a high-pressure mercury lamp upward with an illumination of 200 mW/cm² for 10 seconds, then, a cured product is taken out from the apparatus, an uncured portion attached to the cured product is removed and a thickness of the cured product is measured.

11. The latent curing type epoxy resin composition according to claim 3, wherein a thickness of a cured epoxy resin composition is 70 μm or higher, when the composition is filled in a cylindrical apparatus having a diameter of 14 mm and a height of 8 mm and cured by irradiating ultraviolet rays of a high-pressure mercury lamp upward with an illumination of 200 mW/cm² for 10 seconds, then, a cured product is taken out from the apparatus, an uncured portion attached to the cured product is removed and a thickness of the cured product is measured.

12. The latent curing type epoxy resin composition according to claim 5, wherein a thickness of a cured epoxy resin composition is 70 μm or higher, when the composition is filled in a cylindrical apparatus having a diameter of 14 mm and a height of 8 mm and cured by irradiating ultraviolet rays of a high-pressure mercury lamp upward with an illumination of 200 mW/cm² for 10 seconds, then, a cured product is taken out from the apparatus, an uncured portion attached to the cured product is removed and a thickness of the cured product is measured.

13. The latent curing type epoxy resin composition according to claim 1, wherein it further comprises at least one colorant (E) selected from the group consisting of carbon black, iron black, iron yellow, chrome green and phthalocyanine blue.

14. The latent curing type epoxy resin composition according to claim 2, wherein it further comprises at least one colorant (E) selected from the group consisting of carbon black, iron black, iron yellow, chrome green and phthalocyanine blue.

15. The latent curing type epoxy resin composition according to claim 3, wherein it further comprises at least one colorant (E) selected from the group consisting of carbon black, iron black, iron yellow, chrome green and phthalocyanine blue.

16. The latent curing type epoxy resin composition according to claim 5, wherein it further comprises at least one colorant (E) selected from the group consisting of carbon black, iron black, iron yellow, chrome green and phthalocyanine blue.

17. An electronic part fixed by using the latent curing type epoxy resin composition according to claim 1.

18. An electronic part fixed by using the latent curing type epoxy resin composition according to claim 2.

19. A package to which an electronic image element is attached by using the latent curing type epoxy resin composition according to claim 1.

20. A package to which an electronic image element is attached by using the latent curing type epoxy resin composition according to claim 2.
